(19) United States
(12) Patent Application Publication
(10) Pub. No.: US 2004/0035280 A1
(43) Pub. Date: Feb. 26, 2004

(54) Device for cutting polymer optical-fibre waveguides

(76) Inventors: Hans Poisel, Leinburg (DE); Dieter Moll, N?uuml;rnberg (DE)

Correspondence Address: HARRINGTON & SMITH, LLP, 4 RESEARCH DRIVE, SHELTON, CT, 06484-6212, US

(21) Appl. No.: 10/363,437

(22) PCT Filed: Aug. 30, 2001
(86) PCT No.: PCT/EP01/10028

(30) Foreign Application Priority Data
Sep. 1, 2000 (DE) 100 43 173.9

(51) Int. Cl. G02B 6/00

(52) U.S. Cl. 83/697; 83/913; 385/13

(57) ABSTRACT

The present invention relates to a device for cutting polymeric optical waveguides (POF-LWLs), comprising a lower clamping jaw (2), an upper clamping jaw (3), and a blade (4), the lower and upper clamping jaws (2,3) holding the POF-LWL (5) to be cut at both sides of the cutting point, seen in the axial direction, by application of a radial pressure.

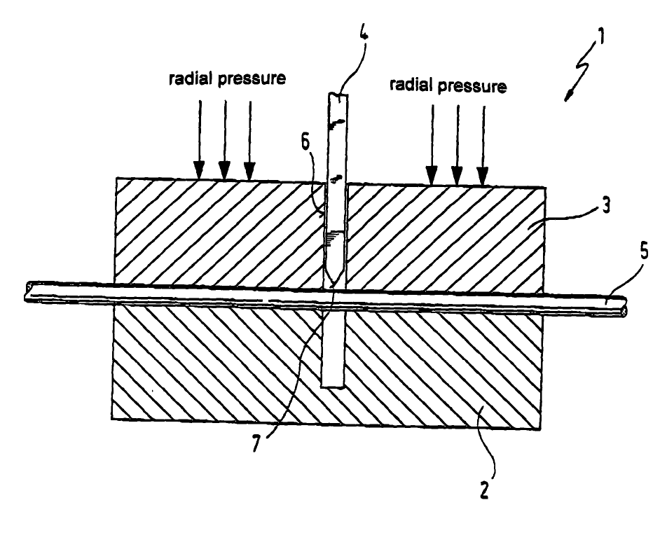

The present invention relates to a device for cutting polymeric optical fiber waveguides (POF-LWLs), comprising a lower clamping jaw, an upper clamping jaw and a blade.

Polymeric optical fibers (POF) are waveguides inter alia used more and more often to transmit data. They consist of transparent synthetic material, e.g. of highly pure PMMA (perspex), and have a typical diameter of 1 mm. They are protected by a cladding extruded thereon so that a typical waveguide cable including a cladding has a diameter of about 2.3 mm. The optical quality of the end face is of decisive importance for coupling light into and out with only little loss, e.g. for plug-and-socket connections. The end face of a POF-LWL should be reflecting, smooth and plane and be perpendicular to the fiber axis; it should show no bursts, produce as little flare light as possible and have no additional changes in refractive index, e.g. resulting from inclusions in the region underneath the end face. It should also be possible to produce such an end face simply, i.e. in a rapidly reproducible and cost-effective way.

Several processes of manufacturing such an end face are known, which depending on the quality standard made on the end face are more or less costly and time-consuming. For example, in the case of less demanding applications it is possible to produce an end face by simply cutting it off, usually using a guided blade, similar to a razor blade. Such a process and tongs designed for this purpose are known from DE 198 42 122 A1. In the case of rather great demands such end faces are subsequently treated by grinding and polishing or by hot-plating, i.e. melting off the end faces on a polished surface. The thus obtained increase in the quality of the end face is achieved at the expense of additional labor input which in the case of large numbers of items is of major consequence.

It is the object of the present invention to improve a device of the above described type such that the end faces of POF-LWL can be produced in only one operating sequence with high quality, i.e. the least possible attenuation.

This object is achieved according to the claims.

Features of preferred embodiments of the present invention are characterized in the subclaims.

The present invention is based on the concept of creating equal conditions on both sides of the cutting face to be made by applying a radial pressure to both sides. As a result, it is prevented, inter alia, that the end face adopts an angle of about 80° with respect to the POF axis, which is the case for devices where the waveguide is only clamped on one side. In the latter case, the cutting blade is deflected towards the side of reduced compressive strain and thus reduced strength, thus producing an oblique cut face. The article “New Fiber Termination Methods for Low Loss Connections” by G. J. Shevchuk et al., Bell Labs, Lucent Technologies, Proc. POF Conference 1999, Chiba (Japan), Post Deadline Paper, page 52 et seq., describes such problems of conventional techniques. In another process where the waveguide is exposed to axial stress, bursts resulting in greater attenuation form at the edge of the cut face.

The invention is explained in more detail below by means of the description of an embodiment with reference to the single FIGURE.

The FIGURE shows a longitudinal section of the device according to the invention for cutting the POF-LWLs. Device 1 has substantially a lower clamping jaw 2 and an upper clamping jaw 3 as well as a blade 4. Waveguide 5 surrounded by an extruded cladding is inserted in a groove having a semicircular cross-section of the lower clamping jaw. The diameter of the groove is slightly smaller than the diameter of the waveguide cable, i.e. if the cable diameter is 2.3 mm, the diameter of the groove will be 2.2 mm by order of magnitude. A corresponding groove is incorporated into the upper clamping jaw 3 locking the waveguide cable 5 from above. Both clamping jaws are pressed towards each other to exert a defined radial pressure on waveguide cable 5.

The edges of the grooves in the lower and upper clamping jaws 2,3 are preferably slightly chamfered or rounded to prevent a bead of the cladding material of the waveguide cable from being formed in the area of the contact surface of the lower and upper clamping jaws. Blade 4 is guided in a slot 6 which in the cutting area fully traverses the upper clamping jaw and partially traverses the lower clamping jaw. Slot 6 guides blade 4 with the least possible play to prevent the escape of the cutting surface in the axial direction. Cutting edge 7 of blade 4 is ground symmetrically and has the least possible wedge angle which as a function of the blade material enables cutting of the waveguides without destroying the blade. As a result of the symmetric grinding of the blade both cut faces of the cut waveguide are perfect. The cut by the blade may be made along an axis passing through the waveguide and the movement may be linear, however, it is also possible to perform a drawing cut, i.e. the blade is moved obliquely to the front or rear in gap 6 while the waveguide is cut.

In order to obtain an optimum cut face it is important that a radial pressure is applied to the waveguide on both sides of slot 6 and equal conditions prevail on both sides of the blade. It should also be prevented that the critical breaking speed of the fiber material is not exceeded during the cutting step, as a result of which breaks might spread into the fiber interior. In the case of PMMA this is 340 m/s. In this connection, the wedge angle of the cutting edge of the blade is also important, which should be as small as possible to also keep the axial compressive load of the cut face at a minimum. Here, it is necessary to make a comprise between the hardness of the blade material and the possible blade sharpening. It has turned out that when a diamond saw is used the surface quality of the cut face is even better than with processes where the cut face is finished by hot-plate methods or polishing.

According to a variant (not shown) of the present invention, it sometimes also proved advantageous to axially pre-stress the waveguide simultaneously with the exertion of a radial pressure. To this end, the device shown should be modified so as to enable an axial application of pressure. This can be done e.g. by a spindle mechanism or the like.

The description of the embodiment only serves for illustrative purposes and should not be considered a limitation.

1. A device for cutting polymeric optical fiber waveguides (POF-LWLs), comprising
a lower clamping jaw (2),
an upper clamping jaw (3), and
a blade (4),
characterized in that
the lower and upper clamping jaws (2,3) hold the POF-LWL (5) to be cut at both sides of the cutting point, seen in axial direction, by application of a radial pressure.

2. The device according to claim 1, characterized in that the upper and lower clamping jaws (3,2) each are designed integrally and the blade (4) is guided in a slot (6) in the clamping jaws (2,3) at minimum play, transversely to the axial direction.

3. The device according to claim 1 or claim 2, characterized in that the upper and lower clamping jaws (3,2) each have a guiding groove of semicircular cross-section.

4. The device according to claim 3, characterized in that for cutting the POF-LWLs (5) with their claddings the diameter of the guiding groove cross-section is dimensioned, by order of magnitude, 0.1 mm smaller than specified for the fiber cladding diameter.

5. The device according to claim 3, characterized in that for cutting the POF-LWL (5) without cladding the diameter of the guiding groove cross-section is substantially equal to the fiber cross-section with slight lower deviation.

6. The device according to claim 3, claim 4 or claim 5, characterized in that the edges of the guiding grooves at the clamping jaw surface (2,3) are slightly chamfered or rounded towards the outside for avoiding pinching of the material.

7. The device according to one of the preceding claims, characterized in that the blade (4) has a symmetrically ground cutting edge (7) of smallest admissible wedge angle.

8. The device according to one of the claims 3 to 7, characterized in that the clamping jaws (2,3) each consists of two parts and allow a pre-stressing of the POF-LWLs (5) in axial direction.

9. The device according to one of the preceding claims, characterized in that the blade (4) is guided in such a way that it applies a drawing cut at the POF-LWLs.
